(19) United States
(12) Patent Application Publication
(10) Pub. No.: US 2024/0361962 A1
(43) Pub. Date: Oct. 31, 2024

(54) INFORMATION PROCESSING DEVICE, INFORMATION PROCESSING SYSTEM, AND INFORMATION PROCESSING METHOD

(71) Applicant: SHARP KABUSHIKI KAISHA, Sakai City (JP)

(72) Inventor: KAZUHISA KUBOTA, Sakai City (JP)

(21) Appl. No.: 18/622,077

(22) Filed: Mar. 29, 2024

(30) Foreign Application Priority Data
Apr. 25, 2023 (JP) 2023-071206

(51) Int. Cl. G06F 3/12

(52) U.S. Cl. CPC G06F 3/1205; G06F 3/1257

(57) ABSTRACT

An information processing device comprises one or more storages capable of storing setting contents of one or more functions included in a job, and one or more controllers that cause the one or more storages to store the setting contents in units of functions.

### CROSS-REFERENCE TO RELATED APPLICATION

The present application claims priority from Japanese Application JP2023-071206, the content to which is hereby incorporated by reference into this application.

### BACKGROUND OF THE INVENTION

### 1. Field of the Invention

The disclosure relates to an information processing device, an information processing system, and an information processing method.

### 2. Description of the Related Art

There has been known a function of storing a series of processes to be executed in an information processing device. For example, a device that registers setting information when each application is executed and allows a user to establish setting information in each application has been known.

### SUMMARY OF THE INVENTION

However, depending on the display screen of the device, the content of the stored series of processes may not be entirely displayed on the display screen, and the user may not be able to check the content of the stored series of processes on the display screen. When a series of processes is automatically registered or when another user registers a series of processes, a user who has not registered the series of processes may not know the content of the registered series of processes. In this case, the user cannot use the registered series of processes. Thus, different users may register the same or similar series of processes.

When the number of registered series of processes is large, it may be difficult for the user to find a series of processes that the user wants to use by operating the device when the registered series of processes is executed by the device. When the user freely names the registered series of processes, it is difficult for another user to know the content of the registered series of processes only by viewing the name.

The disclosure is made in view of the above-mentioned problems. An object of the disclosure is to provide an information processing device, an information processing system, and an information processing method that can improve convenience.

An information processing device according to an aspect of the disclosure includes: one or more storages capable of storing setting contents of one or more functions included in a job; and one or more controllers that cause the one or more storages to store the setting contents in units of functions.

An information processing system according to an aspect of the disclosure includes: an information processing device that executes a job; and a terminal device that is connected to the information processing device to communicate information and stores setting contents of one or more functions included in the job in units of functions.

An information processing method is executed by an information processing device capable of storing setting contents of one or more functions included in a job, the method including storing the setting contents in units of functions.

According to the disclosure, it is possible to provide an information processing device, an information processing system, and an information processing method that are capable of improving convenience.

### BRIEF DESCRIPTION OF THE DRAWINGS

FIG. 1 is a functional block diagram illustrating an example of a schematic configuration of an information processing device according to an embodiment.

FIG. 2 is a flowchart illustrating an example of a process executed by the controller in FIG. 1.

FIG. 3 is a diagram illustrating an example of a job.

FIG. 4 is a diagram illustrating an example of the setting contents stored in the storage in FIG. 1.

FIG. 5 is a flowchart illustrating an example of a process of executing a new job on the basis on of setting contents stored in the storage in FIG. 1 in units of functions.

FIG. 6 is a diagram illustrating a display screen for displaying a list of setting contents displayed on the display in FIG. 1 in units of functions.

FIG. 7 is a diagram illustrating a display screen for displaying a list of setting contents displayed on the display in FIG. 1 in units of functions.

FIG. 8 is a functional block diagram illustrating an example of a schematic configuration of an information processing system according to an embodiment.

### DETAILED DESCRIPTION OF THE INVENTION

Embodiments of the disclosure is described below with reference to the drawings. In the drawings, the same or equivalent components are denoted by the same symbols, and descriptions of the same or equivalent components are omitted without repeating them.

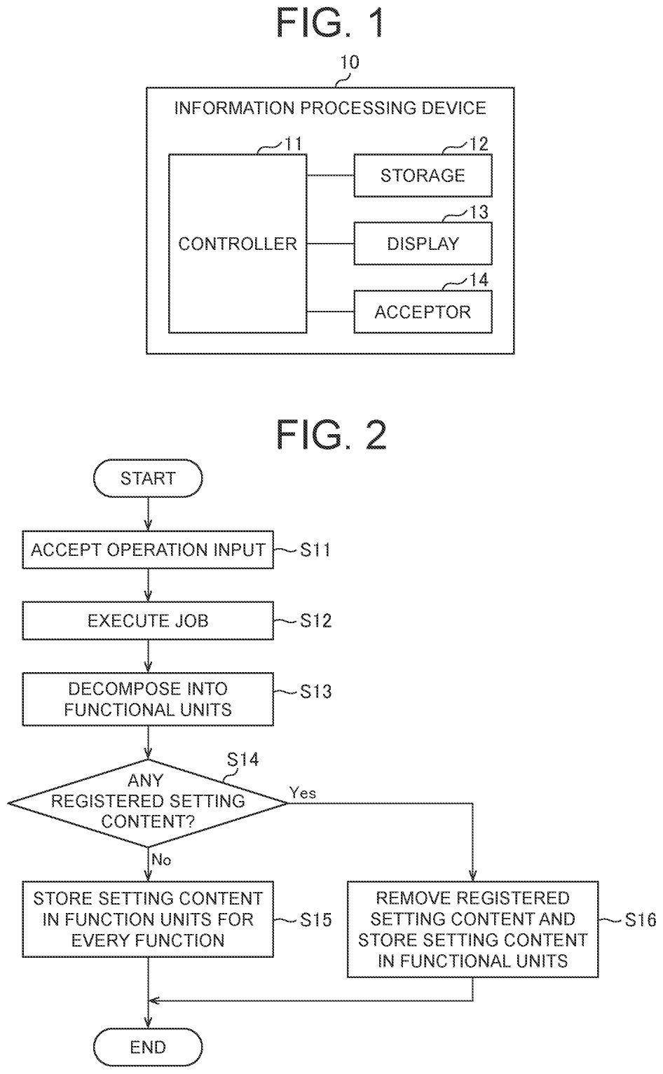

FIG. 1 is a functional block diagram illustrating an example of a schematic configuration of an information processing device 10 according to an embodiment. The information processing device 10 can execute a predetermined process on the basis of a job that combines the setting contents of at least one function. Herein, as an example, the information processing device 10 is described below as a multifunction peripheral capable of executing processes such as copying, facsimile (FAX), scanning, and printing.

The job is configured as a combination of the setting contents of at least one function. The function is a setting item that can be selected by a user as desired in each process. For example, the setting items (functions) selectable in the copy process include color mode, copy sheet, double-sided mode, magnification, density, post-processing, and the like. The color mode setting is related to whether or not to perform color copying, and can be selected from, for example, color, monochrome, and automatic as a specific setting. The copy sheet setting is related to sheets on which copy images are formed and can be selected from, for example, various sheet sizes (B5, B4, A4, A3, etc.), card, postcard, and envelope as a specific setting. The double-sided mode setting is related to whether or not to perform double-sided copying and can be selected from, for example, single-sided or double-sided as a specific setting. In the double-sided mode, it may further be possible to select whether the document to be copied in a single-sided mode or a double-sided mode. Accordingly, these modes can be combined to select copy from one side to one side, copy from one side to both sides, copy from both sides to one side, or copy from both sides to both sides. When double-sided copying is performed in the double-sided mode, the orientation in which the double-sided copying is to be performed can be selected. The magnification setting is related to the magnification of copying and can be selected from, for example, a predetermined appropriate range. The density setting is related to the copy density and can be selected from, for example, automatic, light, or dark. The post-processing is applied to the sheet obtained after copying and can be selected from, for example, sorting, sheet folding, and two-hole punch. In the copy processing, the number of copies may also be set. That is, the number of copies to be made may be set by the copy function.

The functions may be provided for the respective processes executable by the information processing device 10. Therefore, selectable setting items may be provided for processes other than the copy process. For example, the setting items selectable in the fax process may include destination name, document, density, image quality, and the like. The destination name setting is related to the destination of the fax transmission and can be selected from, for example, predefined destination names. The document setting is related to the fax transmission document and can be selected from, for example, various paper sizes (B5, B4, A4, A3, etc.), card, postcard, or envelope, as a specific setting. The density setting is related to the reading density of a document for fax transmission and can be selected from, for example, automatic, light, and dark. The image quality setting is related to image quality of a fax document being transmitted and can be selected from, for example, normal, fine, and high definition, as a specific setting.

The functions may be provided for processes other than the processes specifically described above. For example, selectable setting items may be provided as functions for a scan process and a print process.

As illustrated in FIG. 1, the information processing device 10 includes, as functional units, a controller 11, a storage 12, a display 13, and an acceptor 14.

The controller 11 comprehensively controls and manages the information processing device 10 including the respective functional units of the information processing device 10. The controller 11 executes various controls, for example, by running control programs stored in the storage 12. For example, the controller 11 can be composed of a control device such as at least one central processing unit (CPU) or at least one micro processing unit (MPU).

The controller 11 executes processing on the basis of a user's operation input accepted by the acceptor 14 to be described later. For example, the controller 11 executes processing such as copying, faxing, scanning, and printing on the basis of the user's operation input accepted by the acceptor 14. When the controller 11 executes a process in a case where the setting items are selected for one or more functions with the acceptor 14, the controller 11 executes a job that combines the setting contents of at least one function on the basis of the selection.

In the present embodiment, the controller 11 stores the setting contents of related functions in the storage 12 in units of functions. For example, when a job is executed, for example, on the basis of a user's operation input, the controller 11 can automatically store the setting contents of at least one function included in the executed job in the storage 12 in units of functions. Alternatively, the controller 11 may be composed to be able to store the setting contents in the storage 12 in units of functions on the basis of predetermined operation input for storing (registering) the setting contents by the user. Details of the process of storing the setting contents in units of functions by the controller 11 will be described later.

The controller 11 controls the display content on the display 13 on the basis of the information on the setting contents stored in the storage 12. For example, the controller 11 displays the setting contents stored in the storage 12 in units of functions as a list on the display 13. Details of the control of the display content by the controller 11 will be described later.

The storage 12 is a storage medium capable of storing programs and data. The storage 12 can be composed of, for example, a semiconductor memory or a magnetic memory. Specifically, the storage 12 can be composed of, for example, by at least one electrically erasable programmable read-only memory (EEPROM). The storage 12 may store, for example, programs for operating the controller 11.

In the present embodiment, the storage 12 stores the setting contents of the functions in units of functions. For example, every time the controller 11 executes a job on the basis of a user's operation input, the storage 12 stores the setting contents for the functions included in the job in units of functions. In this way, the setting contents of the functions included in the executed job are stored in the storage 12 in units of functions. In this way, the storage 12 can accumulate the setting contents of the functions included in the jobs executed in the past as a history.

The display 13 is a device that displays images. The display 13 may be composed of a well-known display such as a liquid crystal display (LCD), an organic electro-luminescence display (OELD), or an inorganic electro-luminescence display (IELD). The display 13 displays various types of information on the basis of the control of the controller 11. Specifically, the display 13 displays, for example, the processes that the information processing device 10 can execute. The display 13 displays information on functions selectable by a user.

The acceptor 14 accepts an operation input from a user. In the present embodiment, the acceptor 14 accepts an input by a user of a process to be executed by the information processing device 10. The acceptor 14 may also receive an input for selecting each function.

The acceptor 14 can be composed of, for example, a touch panel. The touch panel can be composed by a known method such as a capacitive method, a resistive film method, an infrared blocking method, or an ultrasonic surface acoustic wave method. The acceptor 14 may be positioned on the display 13 if the acceptor 14 is composed of a touch panel. For example, the acceptor 14, or the touch panel, may be composed of, for example, transparent acrylic resin, and the image displayed on the display 13 may be visible through the touch panel. When a user touches the acceptor 14 composed of a touch panel for operation input, the position of the touch is detected, and processing corresponding to the detected position of the touch is executed.

In the information processing device 10 according to the present embodiment, a user performs an operation input based on information displayed on the display 13. The acceptor 14 accepts the operation input, and the controller 11 executes a process corresponding to the accepted operation input.

For example, processes executable by the information processing device 10 are displayed on the display 13. When a user performs an operation input to the acceptor 14 to execute a predetermined process, the controller 11 executes a process in accordance with the operation input, such as copying, faxing, scanning, or printing.

For example, the display 13 displays input buttons for allowing the user to select the setting contents of each function when the user causes a process to be executed. The acceptor 14 can accept selection of a setting content related to a function. As an example, when the copy process is executed, input buttons for selecting the setting contents of color mode, copy sheet, double-sided mode, magnification, density, and post-processing are displayed on the display 13. When a user performs operation input to select the input button for selecting the setting content of color mode, the acceptor 14 accepts the operation input, and the controller 11 causes the display 13 to display the input button for selecting any one of color, monochrome, and automatic as the setting content selectable in the color mode. The user performs operation input to select one of color, monochrome, and automatic. When the acceptor 14 accepts the operation input, the setting content of the function of color mode is selected (determined). The same applies to the other functions. That is, a user can select the desired setting contents by performing operation input in accordance with the display content on the display 13 for the respective functions of copy sheet, double-sided mode, magnification, density, and post-processing. As described in this paragraph, the method of individually selecting the setting content of each function is hereinafter also referred to as “individual function setting.”

The display 13 can display the setting contents stored in the storage 12 under the control of the controller 11. For example, it is assumed that a user performs operation input for displaying the setting contents stored in the storage 12. When the acceptor 14 accepts the operation input, the controller 11 refers to the setting contents stored in the storage 12 in units of functions on the basis of the operation input, and displays the setting contents in units of functions stored in the storage 12. A user performs operation input to select one or more setting contents from the setting contents displayed on the display 13 in units of functions. The acceptor 14 accepts operation input for selecting one or more setting contents from the setting contents displayed on the display 13 in units of functions. In this case, the controller 11 executes a new job including the function of the one or more selected setting contents. As described in this paragraph, the method of selecting the setting content of each function on the basis of the setting contents stored in the storage 12 in units of functions is hereinafter also referred to as “function setting based on registered setting content.”

The information processing device 10 includes a functional unit for executing processing in addition to the functional units described above. Specifically, the information processing device 10 includes functional units for executing processes such as copying, faxing, scanning, and printing. These functional units can be implemented by known configurations.

Next, specific examples of processes executed by the controller 11 of the information processing device 10 is described with reference to flowcharts. FIG. 2 is a flowchart illustrating an example of a process executed by the controller 11. Specifically, FIG. 2 illustrates an example of a process in which the controller 11 automatically stores (registers) the setting contents in units of functions when a job is executed.

First, the acceptor 14 of the controller 11 accepts operation input for executing a predetermined process from a user (step S11). Specifically, the user performs operation input for executing a predetermined process by using the information processing device 10. The controller 11 accepts the operation input. At this time, the user selects a setting item of each function as desired. That is, the user performs individual function setting. In this case, the user performs operation input for selecting setting items one by one for each function. For example, it is assumed that the user intends to execute a job “color: monochrome/document: A5/sheet: tray 2, A3, plain paper/sheet folding: saddle folding (outer).” In this case, the user performs predetermined operation input to the acceptor 14 to select the setting of “monochrome” from three settings of, for example, “monochrome,” “color,” and “automatic” for the function of “color.” Similarly, the user performs predetermined operation input to the acceptor 14 to select the setting “A5” from the settings “A3,” “A4,” “A5,” “B3,” “B4,” and “B5” for the function “document.” Similarly, operation input for selecting the settings in unit of function for the functions “paper” and “sheet folding” is performed.

In this way, on the basis of the operation input performed by the user, the controller 11 accepts the input of the selection of the setting item of each function. In this way, the controller 11 can accept a job to be executed.

The controller 11 executes the job on the basis of the operation input received in step S11 (step S12). For example, when the controller 11 accepts operation input for executing the copy process in step S11, the controller 11 executes the copy process in step S12. At this time, the controller 11 executes the copy process in accordance with the job accepted in step S11.

In the flow illustrated in FIG. 2, after the job is executed in step S12, the controller 11 automatically stores (registers) the setting contents of the functions included in the executed job in the storage 12 in units of functions.

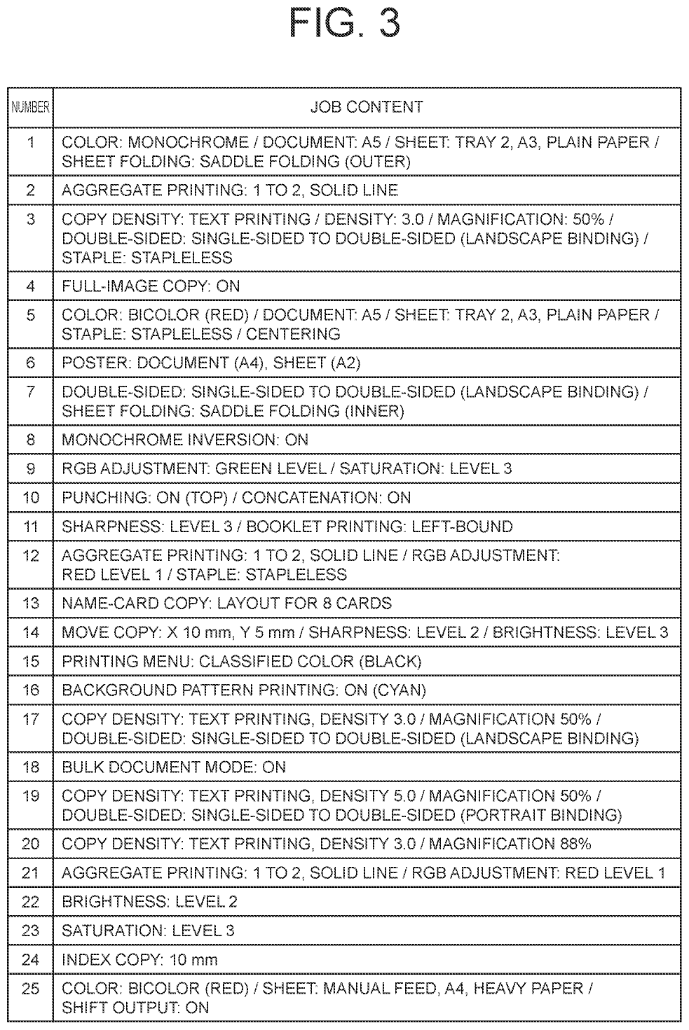

Specifically, the controller 11 decomposes the executed job into units of functions (step S13). FIG. 3 is a diagram illustrating an example of a job. In FIG. 3, examples of jobs are provided as a list. In FIG. 3, the content of the job associated with each number for each row is the content of one job, that is, one or more functions included in one job. Here, it is assumed that the list of jobs illustrated in FIG. 3 is a list of jobs executed by the controller 11 of the information processing device 10. In the list of jobs illustrated in FIG. 3, it is assumed that a job with a smaller number is a job executed later. That is, in the list of jobs illustrated in FIG. 3, it is assumed that the job with the number “1” is the latest job that was executed last.

In the example illustrated in FIG. 3, “color: monochrome/document: A5/sheet: tray 2, A3, plain paper/sheet folding: saddle-folding (outer)” is described as the latest job. Here, a slash symbol “/” indicates a delimiter of a unit of function. That is, the latest job in the example illustrated in FIG. 3 is a job including four functions of “color: monochrome,” “document: A5,” “sheet: tray 2, A3, plain paper,” and “sheet folding: saddle folding (outer).” In step S13, the controller 11 decompose the latest job into units of functions such as “color: monochrome,” “document: A5,” “sheet: tray 2, A3, plain paper,” and “sheet folding: saddle folding (outer).”

Next, the controller 11 determines whether or not there is registered setting content for each of the decomposed functions (step S14). For example, the controller 11 determines whether or not the setting content “color: monochrome” is already stored in the storage 12. Similarly, the controller 11 determines whether or not the setting contents of the respective functions of “document: A5,” “sheet: tray 2, A3, plain paper,” and “sheet folding: saddle folding (outer)” are stored in the storage 12.

When the controller 11 determines that there is no registered setting content (No in step S14), the controller 11 stores the setting contents in units of functions for all functions decomposed in step S13 (step S15). In this example, the controller 11 causes the storage 12 to store the setting contents for all of “color: monochrome,” “document: A5,” “sheet: tray 2, A3, plain paper,” and “sheet folding: saddle folding (outer).” In this way, each function included in the executed job is registered.

On the other hand, when the controller 11 determines that registered setting contents exist (Yes in step S14), the controller 11 stores the setting contents in units of functions except for the registered setting contents of the functions decomposed in step S13 (step S16). That is, when a portion of the setting contents of one or more functions included in the job is already stored in the storage 12, the controller 11 does not newly store the portion of the setting contents in the storage 12 in units of functions, but automatically stores the setting contents other than the portion of the setting contents of the setting contents of the one or more functions included in the job in the storage 12 in units of functions. For example, when the setting content “document: A5” is stored in the storage 12, the controller 11 does not newly store, in the storage 12, the setting content “document: A5” already stored in the storage 12, and stores the setting contents “color: monochrome,” “sheet: tray 2, A3, plain paper,” and “sheet folding: saddle folding (outer),” which are other setting contents, in the storage 12 in units of functions. In this way, each function included in the executed job is registered without overlapping with the already registered setting contents.

A case in which the setting contents of functions included in the executed job are stored in the storage 12 in units of functions after the job has been executed in step S12 has been explained with reference to the flow illustrated in FIG. 2. However, the setting contents of the functions included in the job may be stored in the storage 12 before the job is executed. For example, when a job is input by a user, the setting contents may be stored in the storage 12 in units of functions for the functions included in the job.

In FIG. 2, when a job is executed, the setting contents are automatically stored in the storage 12 in units of functions. However, the setting contents may not necessarily be related to the execution of the job. For example, the user may perform operation input for storing the setting contents in the storage 12 on the acceptor 14, and the controller 11 may store the setting contents in the storage 12 in units of functions on the basis of the operation input. For example, when the user performs operation input for registering the setting content “color: monochrome,” the controller 11 stores the setting content “color: monochrome” in the storage 12 on the basis of the operation input.

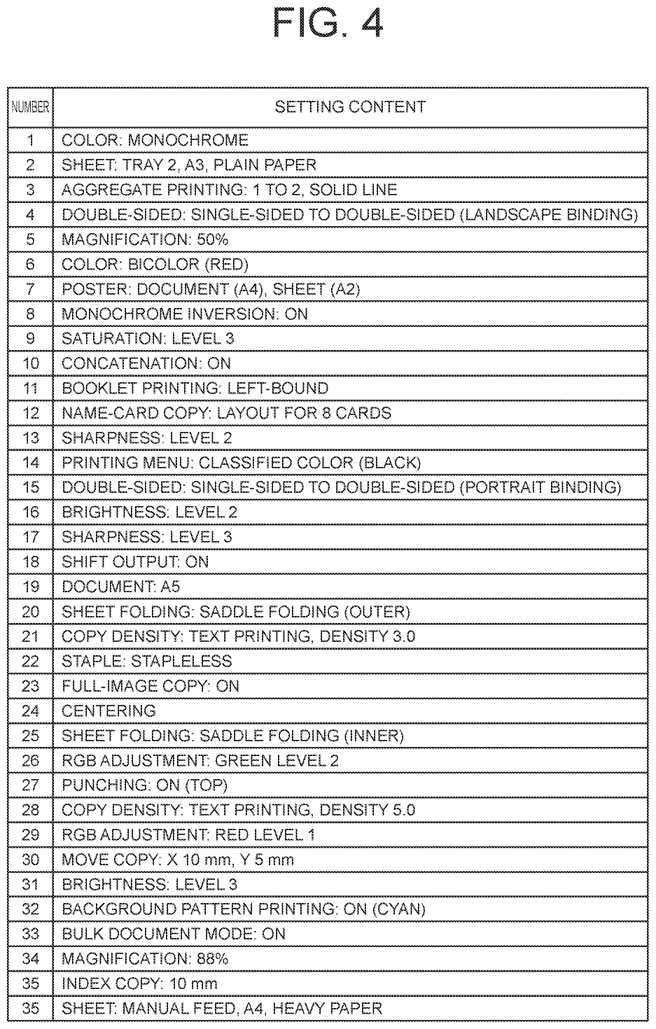

FIG. 4 is a diagram illustrating an example of the setting contents stored in the storage 12. As illustrated in FIG. 4, the setting content are stored in the storage 12 in units of functions. In the example illustrated in FIG. 4, 36 setting contents, numbered “1” to “36,” are stored in units of functions.

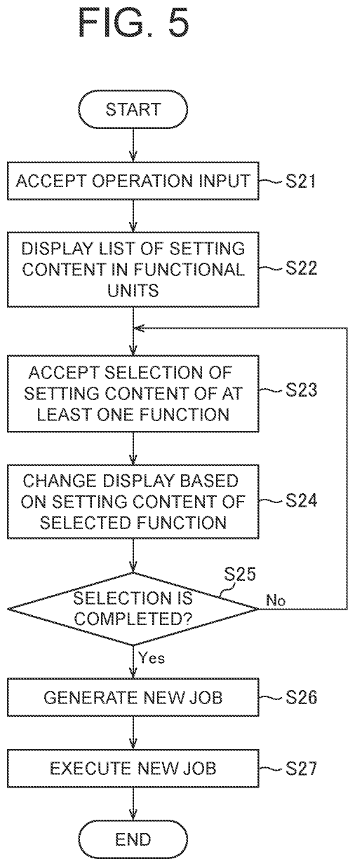

Next, with reference to FIG. 5, an example of processing in a case where a new job is executed on the basis of the setting contents stored in the storage 12 in units of functions will be explained. That is, an example in which a new job is executed by performing function settings based on the registered setting contents instead of individual function settings will be explained.

First, a user performs operation input on the information processing device 10 to display a list of the setting contents stored in the storage 12 in units of functions. The controller 11 causes the acceptor 14 to accept the operation input (step S21).

The controller 11 causes the display 13 to display a list of the setting contents stored in the storage 12 in units of functions on the basis of the operation input accepted in step S21 (step S22).

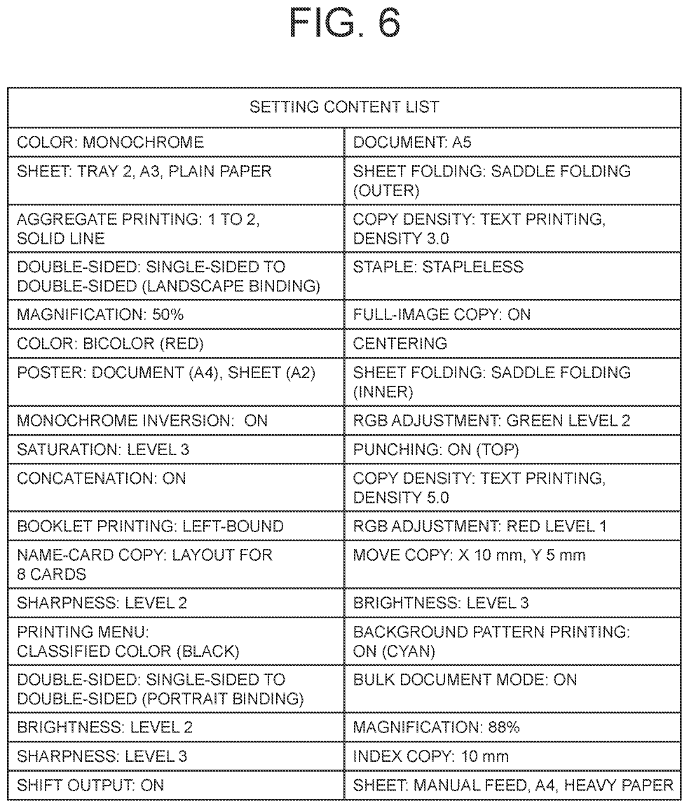

FIG. 6 is a diagram illustrating a display screen for displaying a list of the setting contents displayed on the display 13 in units of functions. The controller 11 causes the display 13 to display the display screen illustrated in FIG. 6 on the basis of the list of the setting contents stored in the storage 12 illustrated in FIG. 4, for example. The controller 11 can display a list of the setting contents stored in the storage 12 in an appropriate arrangement. In the example illustrated in FIG. 6, only the setting contents in units of functions are displayed as a list, but the controller 11 may display the setting contents in units of functions by assigning numbers to the setting contents of the respective units of functions, for example, as illustrated in FIG. 4.

For example, in a state where the display screen illustrated in FIG. 6 is displayed on the display 13, the user performs operation input for selecting the setting contents of one or more functions to be included in the new job to be executed among the setting contents displayed in units of functions. The controller 11 accepts the operation input, that is, the operation input for selecting the setting contents of one or more functions, through the acceptor 14 (step S23).

For example, it is assumed that the user wants to execute a new job “copy density: text printing, density: 3.0/monochrome inversion: ON/double-sided: single-sided to double-sided (landscape binding)/staple: stapleless.” At this time, for example, in a state where the display screen illustrated in FIG. 6 is displayed on the display 13, the user performs operation input for selecting “copy density: text printing, density: 3.0” and “monochrome inversion: ON,” which are the setting contents of functions to be included in the new job. The controller 11 accepts the operation input of selecting “copy density: text printing, density: 3.0” and “monochrome inversion: ON” through the acceptor 14.

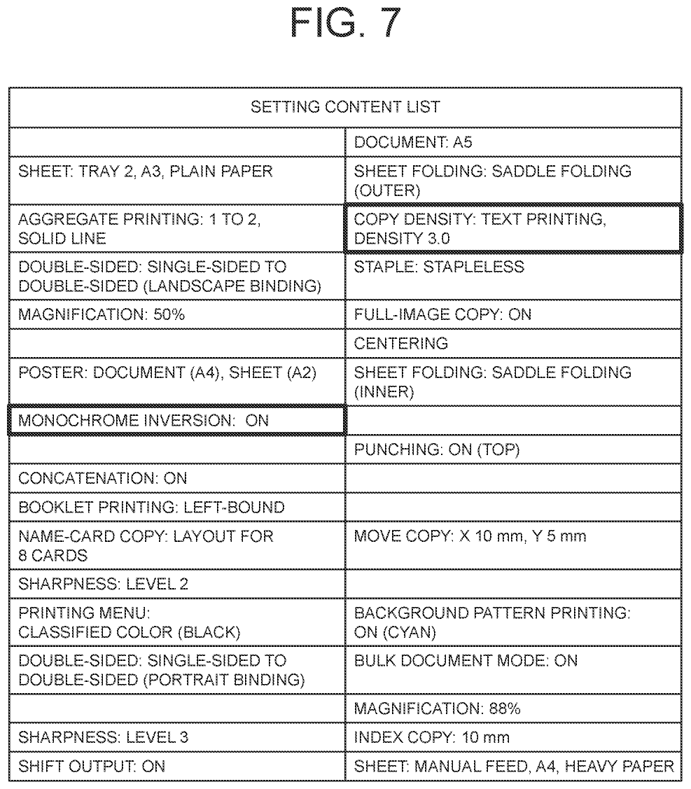

At this time, the controller 11 may display the selected setting contents on the display 13 so as to be distinguishable from other setting contents that are not selected. The controller 11 can distinguishably display the selected setting contents by an appropriate method, and for example, as illustrated in FIG. 7, the controller 11 can distinguishably display the selected setting contents by indicating the selected setting contents with thick frames. However, the method illustrated in FIG. 7 is merely an example, and the controller 11 may distinguishably display the setting contents by an appropriate method such as changing the display size or the display color.

Next, the controller 11 changes the display on the display 13 on the basis of the setting contents of the selected functions (step S24). At this time, the controller 11 changes the display on the display 13 on the basis of the setting contents of the functions for which the selection is accepted in step S23.

For example, the controller 11 causes the display 13 not to display the setting contents related to the setting contents of the selected one or more functions. The setting contents related to the setting contents of the one or more selected functions refers to other setting contents that are selectable as the one or more selected functions of the setting contents. For example, as described above, it is assumed that the setting contents of the function “copy density: text printing, density: 3.0” are selected. In this case, the at least one selected functions of the setting contents are “copy density.” When the setting contents of the function “copy density: text printing, density: 3.0” has already been selected for the function “copy density,” the other setting contents relating to the same function cannot be included in the same job (a single job). For example, “copy density: text printing, density: 5.0” that is another setting content related to the same function “copy density” cannot be included in the same job. Therefore, the controller 11 changes the display such that the setting content (in this example, “copy density: text printing, density: 5.0”) related to the setting contents of the one or more selected functions are not displayed on the display 13, as illustrated in FIG. 7, for example.

In this example, the setting contents of the function “monochrome inversion: ON” is also selected. Therefore, for example, when “monochrome inversion: OFF” or the like is displayed on the display 13 as another setting content of the function of “monochrome inversion,” the controller 11 changes the display so that the setting contents of the function of “monochrome inversion: OFF” are not displayed on the display 13.

The controller 11 can also change the display on the display 13 from another viewpoint. For example, the controller 11 can change the display such that the setting contents that cannot be combined with the setting contents of the one or more selected functions are not displayed on the display 13. For example, as described above, it is assumed that the setting content of the function “monochrome inversion: ON” is selected. In this case, the controller 11 causes the display 13 not to display the setting contents that cannot be combined with the setting content “monochrome inversion: ON.” For example, since the function “RGB adjustment” cannot be combined with the setting content “monochrome inversion: ON,” the controller 11 does not display the setting contents “RGB adjustment: green, level 2” and “RGB adjustment: red, level 1,” as illustrated in FIG. 7. For example, since the functions “brightness” and “saturation” cannot be combined with the setting content “monochrome inversion: ON,” the controller 11 does not display the setting contents “saturation: level 3,” “brightness: level 2,” and “brightness: level 3,” as illustrated in FIG. 7. Moreover, for example, since the setting content of the function “color: bicolor (red)” cannot be combined with the setting content “monochrome inversion: ON,” the controller 11 does not display the setting content “color: bicolor (red),” as shown in FIG. 7. Furthermore, for example, when the setting content “monochrome inversion: ON” is selected, the function “color: monochrome” becomes the setting content selected at the same time, and thus the controller 11 hides the setting content “color: monochrome,” as illustrated in FIG. 7. When the selected function is released (not selected), the setting item that is not displayed is displayed again.

In this way, the controller 11 can change the display on the display 13 on the basis of the setting contents of the functions for which the selection is accepted in step S23. This makes it possible to prevent the user from inputting an inexecutable job by hiding the setting contents that cannot be combined with the selected setting contents into one job. Since the number of options of the setting contents presented to the user is reduced by reducing the number of setting contents being displayed by hiding the setting contents to be displayed, it is possible to make it easy for the user to find other setting contents and to easily select the setting contents.

After changing the display in step S24, the controller 11 determines whether or not the selection of the setting contents by the user is completed (step S25). The controller 11 can determine whether or not the selection of the setting contents is completed by various methods. For example, in the case where an input button indicating that the selection of the setting contents has been completed is displayed on the display 13, the controller 11 can determine that the selection of the setting contents has been completed when the controller 11 detects operation input to the input button. For example, in the case where an input button for starting execution of a job is displayed on the display 13, the controller 11 can determine that the selection of the setting content is completed when the controller 11 detects operation input to the input button. For example, the controller 11 may determine that the selection of the setting contents is completed when a predetermined time elapses in a state in which no operation input is accepted by the acceptor 14.

If the controller 11 determines that the selection of the setting contents by the user is not completed (No in Step S25), the process to proceeds to Step S23 and repeat Step S23 to Step S25. For example, when the user intends to execute a new job of “copy density: character printing, density: 3.0/monochrome inversion: ON/double-sided: single-sided to double-sided (landscape binding)/staple: stapleless” and only the setting contents “copy density: text printing, density: 3.0” and “monochrome inversion: ON” are selected, the user further selects the setting contents “double-sided: single-sided to double-sided (landscape binding)” and “staple: stapleless.” In step S23, the controller 11 accepts the setting contents selected by the user in this way.

Meanwhile, if the controller 11 determines that the selection of the setting contents by the user is completed (Yes in step S25), the controller 11 generates one new job composed of the setting contents of one or more functions accepted in step S23 (step S26). In the above-described example, the controller 11 generates a new job including the setting contents “copy density: text printing, density: 3.0” and “monochrome inversion: ON.”

The controller 11 then executes the new job generated in step S26 (step S27). The controller 11 may execute the new job when separate operation input for executing the new job is accepted by the acceptor 14 from the user.

As described above, in the present embodiment, the controller 11 can store the setting contents in the storage 12 in units of functions. When the setting contents are stored in units of jobs, a plurality of jobs configured with similar setting contents may be registered by a plurality of users, and the memory of the storage 12 may be consumed by the jobs configured with similar setting contents. The expression “stored in the storage 12 in units of jobs” means, for example, storing in the storage 12 a job having setting contents in each row in the example illustrated in FIG. 3. Therefore, for example, the job No. 3 and the job No. 17 in FIG. 3 are separately stored as two jobs, even though they are different only in that they include or do not include the setting content “staple: stapleless.” On the other hand, when the setting contents are stored in units of functions as in the present embodiment, a plurality of similar jobs are not registered, so that the storage capacity of the storage 12 can be used more effectively. When the setting contents are stored in units of functions, the amount of information included in one unit is smaller than that when the setting contents are stored in units of jobs. Therefore, the storage capacity of the storage 12 can be used more effectively.

When the setting contents stored in units of functions are displayed, for example, on the display 13, as illustrated in FIG. 6, the amount of information displayed on the display 13 for each unit decreases because the amount of information included in one unit is small. Therefore, even if the size of the display 13 is small, the entire information included in one unit can be easily displayed on the display 13. For example, when the setting contents are stored in units of jobs, the contents illustrated in FIG. 3 are displayed on the display 13. However, when there are many setting contents constituting a job, the contents to be displayed become large. For this reason, the entire content of the job may not fit in the display 13. In this case, even if the user displays the stored job on the display 13, the user may not be able to check the entire content of the job because the entire content of the job is not contained in the display 13. On the other hand, when the setting contents are stored in units of functions as in the present embodiment, even when the screen of the display 13 is small, for example, the entire setting contents of each function are likely to be displayed, as illustrated in FIG. 6, because the amount of information included in one unit is small. Therefore, the user can easily check the stored setting contents on the display 13. In this way, according to the information processing device 10 of the present embodiment, convenience can be improved.

In step S24 of FIG. 5 described above, the controller 11 can also change the display on the display 13 from another viewpoint. For example, the controller 11 can change the display such that the setting contents related to the functions that are not executable or is prohibited from being executed are not displayed on the display 13.

The expression “not executable” means, for example, that the functions of the information processing device 10 cannot be executed. For example, when the setting contents of a specific function can be attached to the information processing device 10 as an option, the setting contents of the specific function cannot be executed by the information processing device 10 to which the setting contents of the specific function are not attached as an option. As described above, when the option is not attached, the controller 11 can hide the setting contents of the specific function on the display 13 because they are not executable. An example of function that can be optionally attached is a finisher function of automatically performing processing such as stapling, punching, center-folding, or bookbinding on sheets. However, functions that can be optionally attached is not limited to this.

The expression “prohibited from being executed” means that, for example, an administrator or the like of the information processing device 10 establishes a setting to prohibit the execution in the information processing device 10. For example, an administrator or the like can set a specific function such as a finisher function to be disabled in the information processing device 10. In this case, the controller 11 hides the function set to be disabled on the display 13. The administrator or the like can also set whether or not to prohibit the setting contents of a specific function for each user of the information processing device 10. In this case, the setting contents of the function which is not displayed on the display 13 are different for each user.

In this way, by hiding the setting contents related to the function that are not executable or are prohibited from being executed, it is possible to prevent a user from inputting a job that cannot be executed. Since the number of options of the setting contents presented to the user is reduced by reducing the number of setting contents being displayed by hiding the setting contents to be displayed, it is possible to make it easy for the user to find other setting contents and to easily select the setting contents.

In the present embodiment, the controller 11 may cause the display 13 to display a setting content stored at a later time among the setting contents of the functions stored in the storage 12 at a position closer to a predetermined position. The predetermined position is, for example, an upper portion of the screen of the display 13. In this case, for example, in step S22 of FIG. 5, the controller 11 displays the setting contents stored at a later time in an upper portion of the screen. That is, the controller 11 can display the newly stored setting contents in the upper portion of the screen. It is considered that the setting contents newly stored in the storage 12 are highly likely to be used most recently by the user. Therefore, by displaying the newly stored setting contents at a predetermined position (for example, an upper portion), it becomes easy for the user to search for the target setting content. The predetermined position is not necessarily the upper portion of the screen, and can be appropriately determined on the basis of, for example, the arrangement of the display 13 in the information processing device 10.

In the present embodiment, when a portion of the setting contents of one or more functions included in a job is already stored in the storage 12, the controller 11 does not newly store the portion of the setting contents in the storage 12 in units of functions, but automatically stores, in units of functions, setting contents other than the portions of the setting contents among the setting contents of the one or more functions included in the job in the storage 12 (step S16 in FIG. 2). In this case, the controller 11 can store the portions of the setting contents in association with the other setting contents. That is, the controller 11 can associate the portion of the setting contents with other setting contents in the storage 12.

For example, in the example described in step S16 of FIG. 2, the setting content of “document: A5” is already stored in the storage 12, and the setting contents “color: monochrome,” “sheet: tray 2, A3, plain paper,” and “sheet folding: saddle folding (outer)” are newly stored in the storage 12. In this case, the setting content “document: A5” corresponds to the “a portion of the setting content,” and the setting contents “color: monochrome,” “sheet: tray 2, A3, plain paper,” and “sheet folding: saddle folding (outer)” correspond to the “other setting content.” Therefore, the controller 11 can cause the storage 12 to store “document: A5.” which is one of the setting contents, in association with “color: monochrome,” “sheet: tray 2, A3, plain paper,” and “sheet folding: saddle folding (outer),” which are the other setting contents. By associating the setting contents in this way, the setting contents of one or more functions included in one job are stored in association with each other. That is, even when the setting contents are stored in units of functions and the setting contents are not stored in units of jobs, the association of the setting contents in units of jobs can be stored in the storage 12.

The setting contents to be stored in the storage 12 may not necessarily be associated with the setting contents already stored in the storage 12 and the setting contents to be newly stored. For example, as described in step S15 of FIG. 2, even when the setting contents of all the functions included in the job are stored in units of functions, the controller 11 can associate the setting contents of all the functions included in one job with each other. In this way, even when the setting contents are not stored in units of jobs, the association of the setting contents in units of jobs can be stored in the storage 12.

When the setting contents are stored in the storage 12 in association with each other, the controller 11 can display the associated setting contents at positions close to each other on the display 13. For example, as described in step S22 of FIG. 5, when causing the list of the setting contents in units of functions to be displayed on the display screen of the display 13, the controller 11 causes the setting contents associated with each other in the storage 12 to be displayed at positions close to each other (for example, adjacent positions on the upper, lower, left, and right sides). In this way, the setting contents of a plurality of functions included in one job executed in the past can be displayed at positions close to each other. Therefore, when the same job as a job executed in the past to be executed as a new job, it is easy for the user to search for the setting contents of the plurality of functions to be included in the new job because the setting contents of the plurality of functions included in the job executed in the past are displayed at positions close to each other on the display 13.

In the present embodiment, it has been described that the controller 11 stores the setting contents in the storage 12 in units of functions. However, the controller 11 may be configured to be able to store the setting contents in the storage 12 in units of functions and in units of jobs. In this case, for example, for a job executed in the past, the setting contents included in the job are stored in units of functions and also in units of jobs. When the setting contents stored in units of jobs is to be executed, the user performs predetermined operation input to display the setting contents stored in the storage 12 in units of jobs on the display 13, and selects the setting contents desired to be executed from the displayed setting contents in units of jobs, to execute the job composed of the setting contents in units of jobs. In this way, by storing the setting contents also in units of jobs, the user can select the setting contents in units of functions or in units of jobs, thereby improving the convenience.

The controller 11 may determine the units in which the setting contents are to be stored in the storage 12 on the basis of a user's operation input. That is, the controller 11 prompts the user to input whether to store (register) the setting contents in units of functions or in units of jobs. The controller 11 can store the setting contents in units of functions and/or units of jobs on the basis of the user's operation input. In this way, the user can register the setting contents in an appropriate format in accordance with the contents of a job, a use scene, or the like, and thus convenience is further improved.

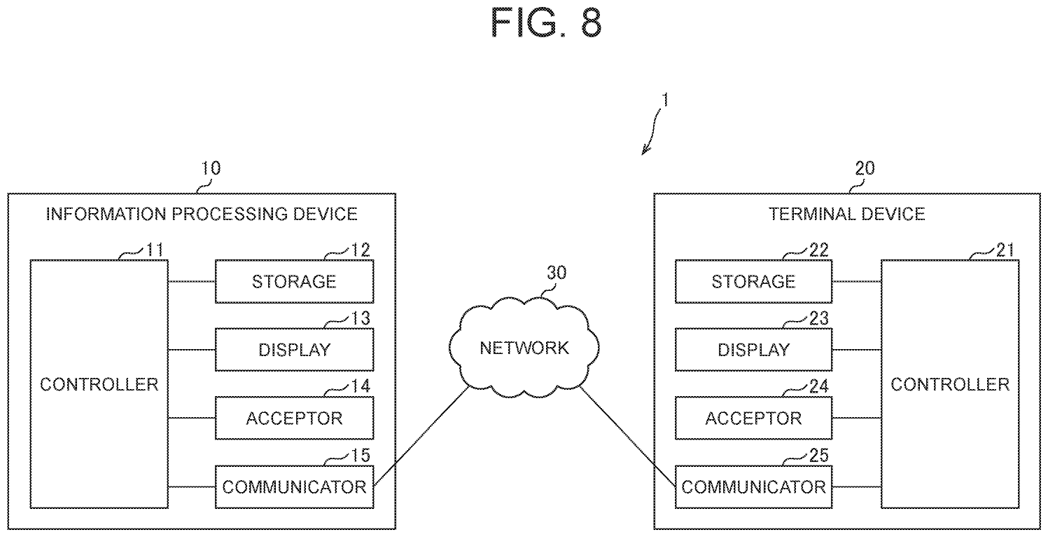

In the present embodiment, an example in which the present disclosure is implemented as an information processing device has been described. However, the present disclosure can also be implemented as an information processing system. FIG. 8 is a functional block diagram illustrating an example of a schematic configuration of an information processing system 1 according to an embodiment.

As illustrated in FIG. 8, the information processing system 1 includes an information processing device 10 and a terminal device 20. The information processing device 10 and the terminal device 20 are connected via a network 30 such as the Internet, so as to be able to communicate information. The information processing device 10 and the terminal device 20 may be connected to each other so as to be able to perform information communication by another method such as Bluetooth (registered trademark) or a wireless local area network (LAN). The information processing device 10 and the terminal device 20 may be connected to each other in a wired or wireless manner so as to be able to communicate information.

The information processing device 10 includes, as functional units, a controller 11, a storage 12, a display 13, an acceptor 14, and a communicator 15. The functions and configurations of the controller 11, the storage 12, the display 13, and the acceptor 14 may be the same as those described with reference to FIG. 1, and thus the description thereof will be omitted here.

The communicator 15 performs information communication with an external device. Here, the communicator 15 performs information communication with the terminal device 20 as an external device. The communicator 15 is configured to include an appropriate interface in accordance with an information communication method. The communicator 15 receives a signal including a command to execute a job from, for example, the terminal device 20 as an external device. When the communicator 15 receives the signal, the controller 11 executes the job on the basis of the command included in the signal.

The terminal device 20 is a device used by a user of the information processing device 10. When there are multiple users of the information processing device 10, each of the users may use one or more terminal devices 20. That is, the information processing system 1 may include a plurality of terminal devices 20. The terminal device 20 can be implemented by, for example, a smartphone or a computer. The terminal device 20 includes, as functional units, a controller 21, a storage 22, a display 23, an acceptor 24, and a communicator 25.

The controller 21 comprehensively controls and manages the terminal device 20 including each functional unit of the terminal device 20. The controller 21 performs various kinds of control by, for example, operating a control program stored in the storage 22. For example, the controller 21 can be implemented by a control device such as a CPU or an MPU.

The controller 21 transmits a signal including a command to execute a predetermined process (for example, a job) to the information processing device 10 on the basis of a user's operation input. In an information processing system 1, the controller 21 of the terminal device 20 stores setting contents related to functions in the storage 22 of the terminal device 20 in units of functions. For example, when a job is executed by the information processing device 10, for example, on the basis of a user's operation input, the controller 21 automatically stores the setting contents of at least one function included in the executed job in the storage 22 in units of functions. For example, the method described with reference to FIG. 2 can be used as the process of storing the setting contents in units of functions.

The controller 21 controls the display content on the display 23 on the basis of information related to the setting contents stored in the storage 22. For example, the controller 21 displays the setting contents stored in the storage 22 in units of functions as a list on the display 23. In this way, in the information processing system 1 as well, the user can perform function setting based on the registered setting contents. That is, for example, as illustrated in FIG. 6, the controller 21 causes the display 23 to display the setting contents stored in the storage 22 in units of functions. The controller 21 causes the acceptor 24 to accept operation input for selecting one or more setting contents from the displayed setting contents in units of functions. The controller 21 transmits, to the information processing device 10, a signal including a command to execute a new job composed of the received one or more setting contents. Upon receiving the signal, the information processing device 10 executes the new job on the basis of the command included in the signal.

The storage 22 is a storage medium capable of storing programs and data. The storage 22 can be composed of, for example, a semiconductor memory or a magnetic memory. Specifically, the storage 22 can be composed of, for example, by an EEPROM. The storage 22 may store, for example, programs for operating the controller 21. The storage 22 stores the setting contents of the functions in units of functions. For example, the setting contents of the functions included in the executed job are stored in the storage 22 in units of functions. In this way, the storage 22 can accumulate the setting contents of the functions included in the jobs executed in the past as a history.

The display 23 is a device that displays images. The display 23 may be composed of a well-known display such as a liquid crystal display, an organic electro-luminescence display, or an inorganic electro-luminescence display. The display 23 displays various information on the basis of the control of the controller 21. Specifically, the display 23 displays, for example, the processes that the information processing device 10 can execute. The display 23 displays information on functions selectable by a user.

The acceptor 24 accepts an operation input from a user. The acceptor 24 includes, for example, operation buttons. When a touch sensor is provided in the display 23, the touch sensor provided in the display 23 may function as the acceptor 24.

The communicator 25 performs information communication with an external device. Here, the communicator 25 performs information communication with the information processing device 10 as an external device. The communicator 25 is configured to include an appropriate interface in accordance with an information communication method. The communicator 25 receives a signal including a command to execute a job from, for example, the information processing device 10 as an external device.

As described above, also in the information processing system 1, the storage capacity of the storage 22 can be more effectively used for the same reason as that of the information processing device 10 described with reference to FIGS. 1 to 7. In particular, in the information processing system 1, since the setting contents are stored in units of functions in the storage 22 of the terminal device 20, it is possible to store the setting contents in units of functions in the storage 22 of the terminal device 20 regardless of the capacity of the storage 12 of the information processing device 10.

In the information processing system 1, each user can store only the setting contents used by the user in each terminal device 20. In this case, since only the setting contents desired by each user can be stored in the storage 22 and displayed on the display 23, the user can easily find the setting contents frequently used by the user. In the information processing system 1, each user can cause a job to be executed by using the terminal device 20 used by the user. Therefore, for example, it is possible to omit time and effort for performing authentication for each user in the information processing device 10. Furthermore, in the information processing system 1, for example, the setting contents stored in the storage 22 in units of functions can be displayed on the display 23 of the terminal device 20. Therefore, even when the display 13 of the information processing device 10 is small, the user is less likely to feel inconvenience. In this way, the display 13 of the information processing device 10 can be reduced in size. In this way, the information processing system 1 can improve convenience.

Although the disclosure has been described on the basis of the drawings and embodiments, it should be noted that a person having ordinary skill in the art can easily make various modifications and variations based on the disclosure. Accordingly, it should be noted that these modifications and variations are included within the scope of the disclosure. For example, the functions included in the respective functional units or steps can be rearranged in a logically consistent manner, and multiple functional units or steps can be combined into one or divided.

In addition, a program operating in each device in the embodiments is a program (a program causing a computer to function) that controls a CPU, or the like, in such a way as to achieve functions of the above-described embodiments. The information handled by these devices is temporarily stored in a temporary storage device (for example, a random-access memory (RAM)) during processing, and then stored in various read-only memories (ROMs), and storage devices, such as hard disk drives (HDDs). The information is retrieved, modified, and written by the CPUs as needed.

A recording medium used for storing the program may be any one of a semiconductor medium (for example, a ROM, a non-volatile memory card, or the like), an optical recording medium or a magnetooptical recording medium (for example, a digital versatile disc (DVD), a magnetooptical disc (MO), a mini disc (MD), a compact disc (CD), a Blu-ray (registered trademark) disc (BD), or the like), and a magnetic recording medium (for example, a magnetic tape, a flexible disk, or the like). Moreover, not only are the functions of the embodiments described above implemented by execution of a loaded program, but the functions of the disclosure may also be implemented by processing performed in cooperation with an operating system or other application programs, etc., on the basis of an instruction of the program.

Furthermore, in a case where the programs are to be distributed to the market, the programs may be stored in a portable recording medium for distribution or transferred to a server computer connected via a network, such as the Internet. In this case, it is needless to say that a storage device of the server computer is also included in the present disclosure.

The functional blocks or the various features of each device used in the above-described embodiment can also be implemented or executed by an electric circuit, such as an integrated circuit or a plurality of integrated circuits. Electric circuit designed to achieve the functions described herein may include a general-purpose processor, a digital signal processor (DSP), an application specific integrated circuit (ASIC), a field programmable gate array (FPGA), or other programmable logic device, discrete gate or transistor logic, discrete hardware components, or any combination thereof. A general-purpose processor may be a microprocessor, and the processor may be also any conventional processor, controller, microcontroller, or state machine. The above-described electric circuit may be configured by a digital circuit or an analog circuit. When advancements in semiconductor technology lead to the emergence of integrated circuit technologies that could replace the current integrated circuits, one or more of the aspects of the present disclosure may be realized using such new integrated circuit.

While there have been described what are at present considered to be certain embodiments of the invention, it will be understood that various modifications may be made thereto, and it is intended that the appended claim cover all such modifications as fall within the true spirit and scope of the invention.

What is claimed is:

1. An information processing device comprising:
one or more storages capable of storing setting contents of one or more functions included in a job; and
one or more controllers that cause the one or more storages to store the setting contents in units of functions.

2. The information processing device according to claim 1, wherein the one or more controllers cause the one or more storages to store the setting contents in units of jobs.

3. The information processing device according to claim 2, wherein the one or more controllers determine units in which the setting contents are to be stored in the one or more storages on a basis of an operation input by a user.

4. The information processing device according to claim 1, further comprising:
a display that displays the setting contents stored in the one or more storages in units of functions; and
an acceptor that accepts operation input to select one or more of the setting contents among the setting contents displayed on the display in units of functions,
wherein the one or more controllers execute a new job including the one or more functions of the selected one or more setting contents.

5. The information processing device according to claim 1, further comprising:
a display that displays the setting contents stored in the one or more storages in units of functions; and
an acceptor that accepts operation input to select one or more of the setting contents among the setting contents displayed on the display in units of functions,
wherein, when one or more of the setting contents displayed on the display in units of functions are selected, the one or more controllers hide the setting contents related to the one or more functions of the selected one or more setting contents, on the display.

6. The information processing device according to claim 1, further comprising:
a display that displays the setting contents stored in the one or more storages in units of functions; and
an acceptor that accepts operation input to select one or more of the setting contents among the setting contents displayed on the display in units of functions,
wherein the one or more controllers hide the setting contents related to the one or more functions not executable or prohibited from being executed, on the display.

7. The information processing device according to claim 1, further comprising:
a display that displays the setting contents stored in the one or more storages in units of functions; and
an acceptor that accepts operation input to select one or more of the setting contents among the setting contents displayed on the display in units of functions,
wherein, when one or more of the setting contents displayed on the display in units of functions are selected, the one or more controllers hide the setting contents that cannot be combined with the selected one or more setting contents, on the display.

8. The information processing device according to claim 1, wherein, when the job is executed, the setting contents of the one or more functions included in the job are automatically stored in the one or more storages in units of functions.

9. The information processing device according to claim 8, wherein,
when a portion of the setting contents of the one or more functions included in the job is already stored in the one or more storages, the portion of the setting contents is not newly stored in the one or more storages in units of functions,
the setting contents other than the portion of the setting contents among the setting contents of the one or more functions included in the job are automatically stored in the one or more storages in units of functions, and
the portion of the setting contents is associated with the other setting contents in the one or more storages.

10. The information processing device according to claim 9, further comprising:
a display that displays the setting contents stored in the one or more storages in units of functions,
wherein the one or more controllers cause the display to display the associated setting contents at positions close to each other.

11. The information processing device according to claim 1, further comprising:
a display that displays the setting contents stored in the one or more storages in units of functions,
wherein the one or more controllers cause the setting contents stored in the one or more storages more recently to be displayed closers to a predetermined position on the display.

12. An information processing system comprising:
an information processing device that executes a job; and
a terminal device that is connected to the information processing device to be able to communicate information therewith and stores setting contents of one or more functions included in the job in units of functions.

13. The information processing system according to claim 12, wherein,
the terminal device displays the setting contents stored in units of functions, and accepts operation input to select one or more of the setting contents among the setting contents displayed in units of functions, and
the information processing device executes a new job including the one or more functions of the one or more setting contents selected in the terminal device.

14. An information processing method executed by an information processing device capable of storing setting contents of one or more functions included in a job, the method comprising:
storing the setting contents in units of functions.
